(19) United States
(12) Patent Application Publication
(10) Pub. No.: US 2010/0259387 A1
(43) Pub. Date: Oct. 14, 2010

(54) ELECTRONIC DEVICE

(75) Inventor: Xue-Fang Jiang, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/512,400

(22) Filed: Jul. 30, 2009

(30) Foreign Application Priority Data
Apr. 11, 2009 (CN) 200910301490.8

(51) Int. Cl. G08B 13/14

(52) U.S. Cl. 340/571

(57) ABSTRACT

An electronic device includes a main body and an anti-theft system positioned in the main body. The anti-theft system includes a control unit, an alert unit, and a sensing unit. The alert unit and the sensing unit are electrically connected to the control unit correspondingly. The sensing unit is arranged on the main body. When the electronic device is at an unlocked state, the alert unit alerts with the sensing unit being touched and the control unit sensing electrical current of human. The sensing unit is formed on the electronic device, and the sensing unit is difficult to be aware of and remove. Therefore, the electronic device has a good anti-theft function.

### BACKGROUND

1. Technical Field

The present disclosure generally relates to electronic devices, and particularly, to an electronic device having anti-theft function.

2. Description of Related Art

Electronic devices such as mobile phones, with build in anti-theft functions have become increasingly popular among consumers.

A typical anti-theft module utilized in a mobile phone includes a main member and an affiliated member. The main member, arranged in a pocket and near the affiliated member, includes a receiver, a control unit, and an alert unit. The receiver, the control unit, and the alert unit are all electrically connected to each other. The affiliated member, hung on the mobile phone, includes an emitter. The receiver can receive electrical signals from the emitter. A safety distance between the main member and the affiliated member is determined by the control unit. The alert unit alerts the users when the distance between the main member and the affiliated member is beyond the safety distance. That is, if the mobile phone together with the affiliated member is stolen, the alert unit would alert the owner of the mobile phone. Therefore, the user may act on it in time.

However, the affiliated member can be removed from the mobile phone easily. The alert unit may not alert when the mobile phone is stolen, in case of the affiliated member is left thereon. Furthermore, the alert unit may not alert either when the main member and the affiliated member are both stolen.

Therefore, there is room for improvement within the art.

### BRIEF DESCRIPTION OF THE DRAWINGS

Many aspects of the exemplary embodiments can be better understood with references to the following drawings. The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a front view of a first exemplary embodiment of an electronic device.

FIG. 2 is a functional block diagram of the electronic device in FIG. 1.

FIG. 3 is functional block diagram of a second exemplary embodiment of an electronic device.

### DETAILED DESCRIPTION

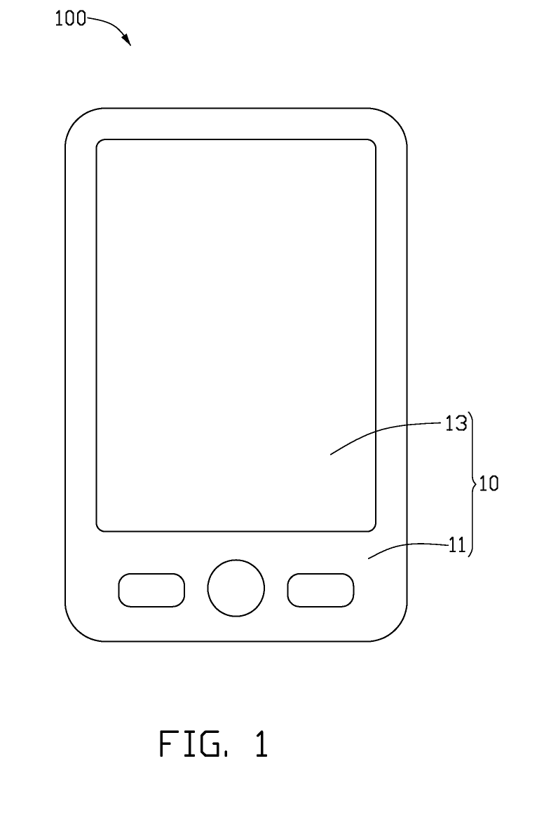

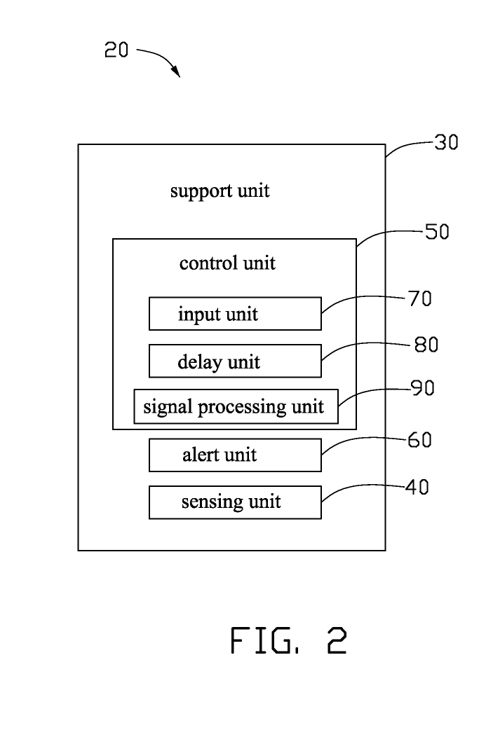

Referring to FIG. 1 and FIG. 2, a first exemplary embodiment of an electronic device 100 may be a mobile phone, including a main body 10 and an anti-theft system 20 positioned in the main body 10. The main body 10 includes a shell 11 and a display screen 13 positioned on the shell 11. The anti-theft system 20 includes a support unit 30, a sensing unit 40, a control unit 50, and an alert unit 60, all electrically connected to each other by the support unit 30 (wiring not shown). The sensing unit 40 can be arranged partially or entirely on the outer surface of the main body 10. In other words, the sensing unit 40 is positioned on at least one of a part of outer surface of the shell 11 and the display screen 13. In this illustrated exemplary embodiment, the sensing unit 40 is arranged on the entire outer surface of the shell 11 and the display screen 13.

The control unit 50 includes an input unit 70, a delay unit 80, and a signal processing unit 90, all electrically connected to each other. The signal processing unit 90 is used to control to lock or unlock the electronic device 100 according to the electrical signals from the input unit 70. The alert unit 60 alerts when the electronic device 100 is locked and the sensing unit 40 is touched. An unlock time is set in the delay unit 80. Once the unlock time passes when the sensing unit 40 is touched, the alert unit 60 generates an alerting signal, unless the electronic device 100 is unlocked. That is because the user must touch the electronic device 100 when unlock the electronic device 100, a suitable time, i.e., the unlock time, should allow the user unlock the electronic device 100, without an undesired alerting. In the illustrated exemplary embodiment, to prevent the alert unit 60 from alerting by any touch, the sensing unit 40 is chosen as a capacitance touch panel. The capacitance touch panel may be formed on the whole surface of the shell 11 and the display screen 13 by in-mold decoration (IMD). A conducting layer of the capacitance touch panel may be made of carbon nanotubes. The input unit 70 may be a keypad set on the main body 10 or a touch panel. The alert unit 60 generates an alerting signal, such signal can be sound, and volume of the sound may gradually increase. Of course, the sound may remain the same.

The unlock time of the electronic device 100 is set and stored in the delay unit 80 beforehand. Generally, the unlock time is set to two or three seconds. When the user is not using the electronic device 100, the electronic device 100 is locked by the signal processing unit 90 with the locked electrical signals input in the input unit 70 and transferred to the signal processing unit 90. When someone steals the electronic device 100, the sensing unit 40 on the outer surface of the electronic device 100 must be touched. An electrical signal is generated and sent to the control unit 50. When the signal processing unit 90 does not receive unlock electrical signals to unlock the electronic device 100 within the unlock time from the input unit 70, the alert unit 60 generates an alerting signal, such signal can be sound, and volume of the sound may gradually increase to warm users that the electronic device 100 may have been stolen. When the user wants to use the electronic device 100, an unlock electrical signal is input in the input unit 70 to unlock the electronic device 100.

The sensing unit 40 on the outer surface of the electronic device 100 is difficult to be aware of and remove. The electronic device 100 is locked by the signal processing unit 90 with the locking electrical signals input into the input unit 70. IF anyone touches the sensing unit 40 without unlocking the electronic device 100 within the unlock time, the alert unit 60 alerts to avoid stolen. Therefore, the electronic device 100 has a good function of anti-theft.

It can be understood that, the input unit 70 may also be an area of fingerprint identification formed on the main body 10. The electronic device 100 is locked or unlocked by touching the area of fingerprint identification. The support unit 30 may be omitted. The sensing unit 40, the control unit 50, and the alert unit 60 are electrically connected to each other by leading wires. The sensing unit 40 may be other electronic elements which can sense electrical current of human, such as a touch switch. The touch switch includes a switching circuit electrically connected to the control unit 50 and a conducting unit formed on the outer surface of the electronic device 100. The control unit 50 starts the alert unit 60 to alert when sensing the changes in the electrical current of the switching circuit after the conducting unit being touched.

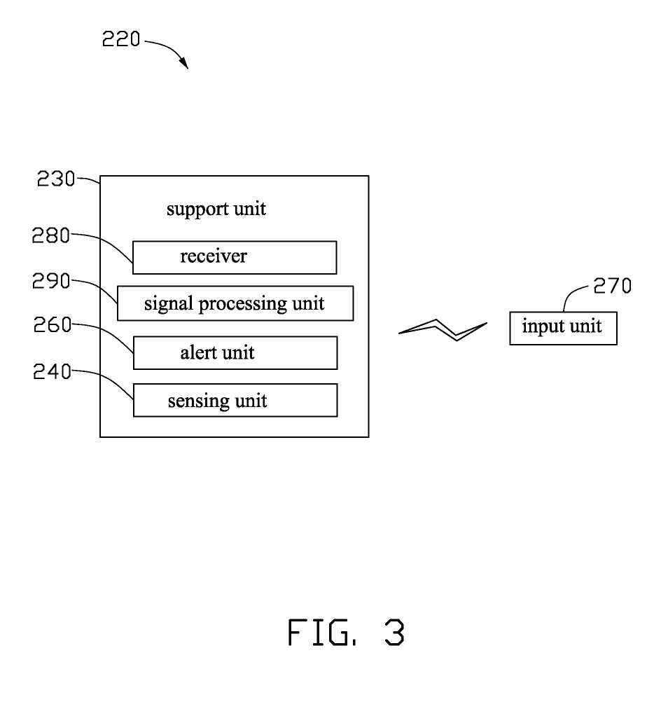

Referring to FIG. 3, an anti-theft system 220 of a second exemplary embodiment of an electronic device (not shown) is similar to the anti-theft system 20 of the first exemplary embodiment, except that a control unit (not labeled) includes an input unit 270, a receiver 280, and a signal processing unit 290, all electrically connected to each other. The input unit 270 is a radio emitter, such as a bluetooth, an infrared, or a general packet radio service. The receiver 280 is used to receive electrical signals from the input unit 270. The electrical signals from the input unit 270 is processed by the signal processing unit 290 to lock or unlock the electronic device.

When the user is not using the electronic device, an electrical signal is sent to the receiver 280 to lock the electronic device by the input unit 280. When someone steals the electronic device, the sensing unit 240 on the outer surface of the electronic device must be touched. An electrical signal is generated and sent to the signal processing unit 290 to start the alert unit 260 to alert. When the user wants to use the electronic device, an unlock electrical signal is input in the input unit 270 to make the signal processing unit 290 unlock the electronic device. A sensing unit 240 is formed on the outer surface of the electronic device, and the sensing unit 240 is difficult to be aware of or remove. In addition, the input unit 270 is a radio emitter, and the electronic device is locked or unlocked by the radio emitter, it needn't touch the electronic device to unlock the electronic device, therefore, it is convenient to use.

Finally, while various exemplary embodiments have been described and illustrated, the disclosure is not to be construed as being limited thereto. Various modifications can be made to the exemplary embodiments by those skilled in the art without departing from the true spirit and scope of the disclosure as defined by the appended claims.

What is claimed is:

1. An electronic device, comprising:
a main body; and
an anti-theft system arranged on the main body, comprising:
a control unit;
a sensing unit arranged on the main body and electrically connected to the control unit; and
an alert unit electrically connected to the control unit;
wherein when the electronic device is in a locked state, the alert unit signals an alert when the sensing unit is touched.

2. The electronic device of claim 1, wherein the sensing unit is formed on the outer surface of the main body.

3. The electronic device of claim 2, wherein the sensing unit is a capacitance touch panel.

4. The electronic device of claim 3, wherein a conducting layer of the capacitance touch panel is made of carbon nano tubes.

5. The electronic device of claim 4, wherein the main body comprises a shell and a display screen positioned on the shell, the capacitance touch panel is formed on the entire surface of the shell and the display screen.

6. The electronic device of claim 1, wherein the sensing unit is a touch switch, comprising a conducting unit formed on the outer surface of the electronic device and a switching circuit electrically connected to the conducting unit.

7. The electronic device of claim 1, wherein the control unit comprises an input unit and a signal processing unit electrically connected to each other, the signal processing unit receives signals from the input unit to lock or unlock the electronic device.

8. The electronic device of claim 7, wherein the input unit is a keypad formed on the main body, the control unit further comprises a delay unit electrically connected to the signal processing unit and the input unit, an unlock time is set and stored in the delay unit.

9. The electronic device of claim 7, wherein the input unit is a radio emitter, the control unit further comprises a receiver electrically connected to the control unit and used to receive the radio signals from the receiver.

10. The electronic device of claim 9, wherein the radio emitter is a bluetooth, an infrared, or a general packet radio service.

11. An electronic device, comprising:
a main body; and
an anti-theft system arranged on the main body, comprising:
a sensing unit arranged on the main body, used to sense touch of human;
a control unit electrically connected to the sensing unit, and
an alert unit electrically connected to the control unit, used to alert when the sensing unit sends the control unit a signal corresponding to human touch.

12. The electronic device of claim 11, wherein the sensing unit is formed on the outer surface of the main body.

13. The electronic device of claim 12, wherein the sensing unit is a capacitance touch panel.

14. The electronic device of claim 13, wherein a conducting layer of the capacitance touch panel is made of carbon nano tubes.

15. The electronic device of claim 14, wherein the main body comprises a shell and a display screen positioned on the shell, the capacitance touch panel is formed on the entire surface of the shell and the display screen.

16. The electronic device of claim 11, wherein the sensing unit is a touch switch, comprising a conducting unit formed on the outer surface of the electronic device and a switching circuit electrically connected to the conducting unit.

17. The electronic device of claim 11, wherein the control unit comprises input unit and a signal processing unit electrically connected to each other, the signal processing unit receives signals from the input unit to lock or unlock the electronic device.

18. The electronic device of claim 17, wherein the input unit is a keypad formed on the main body, the control unit further comprises a delay unit electrically connected to the signal processing unit and the input unit, an unlock time is set and stored in the delay unit.

19. The electronic device of claim 17, wherein the input unit is a radio emitter, the control unit further comprises a receiver electrically connected to the control unit and used to receive the radio signals from the receiver.

20. The electronic device of claim 19, wherein the radio emitter is a bluetooth, an infrared, or a general packet radio service.
